(19) United States
(12) Patent Application Publication
(10) Pub. No.: US 2025/0119896 A1
(43) Pub. Date: Apr. 10, 2025

(54) SCHEDULING CONTROL APPARATUS, SCHEDULING CONTROL SYSTEM, SCHEDULING CONTROL METHOD, AND PROGRAM

(71) Applicant: NIPPON TELEGRAPH AND TELEPHONE CORPORATION, Tokyo (JP)

(72) Inventors: Toshiro NAKAHIRA, Tokyo (JP); Daisuke MURAYAMA, Tokyo (JP); So TAKATANI, Tokyo (JP); Motoharu SASAKI, Tokyo (JP); Kenichi KAWAMURA, Tokyo (JP); Takatsune MORIYAMA, Tokyo (JP)

(21) Appl. No.: 18/832,259

(22) PCT Filed: Feb. 16, 2022
(86) PCT No.: PCT/JP2022/006258

§ 371 Date: Jul. 23, 2024

(51) Int. Cl. H04W 72/12

(52) U.S. Cl. CPC H04W 72/12

(57) ABSTRACT

A scheduling control apparatus that calculates a weight for scheduling a terminal in a wireless system including a plurality of base stations includes: an information acquisition unit configured to acquire information regarding a connection state between each of the plurality of base stations and the terminal; a weight calculation unit configured to calculate, for each base station of the plurality of base stations, a weight indicating an allocation ratio of communication amounts between one or a plurality of terminals connected to the base station; and a control unit configured to notify the base station of the weight. The weight calculation unit calculates the weight by repeating processing for updating the weight so that an error between expected wireless communication quality obtained when the weight is given to each of the terminals and required wireless communication quality of each of the terminals is small.

### TECHNICAL FIELD

The present invention relates to a scheduling method in wireless communication.

### BACKGROUND ART

In wireless systems of the related art, a plurality of terminals are connected to a base station, and the base station determines which terminal to communicate with in every time slot. This determination processing is called scheduling. This may be called user scheduling. For scheduling, a method such as proportional fairness is used (NPL 1).

In proportional fairness, radio resources are allocated to terminals in which instantaneous throughputs expected when the radio resources are allocated is greater than an average throughput until that time.

### CITATION LIST

### Non Patent Literature

NPL 1: “Forest of knowledge” (http://www.Ieice-hbkb.org/)4 Group-3, Volume-3, Chapter<ver.1/2011.09.12> Kanbayashi, retrieved on Feb. 1, 2023

### SUMMARY OF INVENTION

### Technical Problem

In recent years, areas where a plurality of base stations of different types are installed have increased. In areas where a plurality of base stations of different types are installed, situations in which connection destination base stations of terminals and wireless schemes (communication schemes) are different are assumed.

On the other hand, scheduling according to the technology of the related art has been performed in accordance with wireless communication quality, priority, or the like in a base station. Therefore, in the technology of the related art, a plurality of base stations of different types are installed, and there is a problem that scheduling cannot be appropriately performed in situations in which connection destination base stations of terminals and wireless schemes are different.

The present invention has been devised in view of the foregoing circumstances and an object of the present invention is to provide a technology for appropriately performing scheduling in a wireless system in which a plurality of base stations provide services to users.

### Solution to Problem

According to the disclosed technology, a scheduling control apparatus calculates a weight for scheduling a terminal in a wireless system including a plurality of base stations. The scheduling control apparatus includes: an information acquisition unit configured to acquire information regarding a connection state between each of the plurality of base stations and the terminal;
a weight calculation unit configured to calculate, for each base station of the plurality of base stations, a weight indicating an allocation ratio of communication amounts between one or a plurality of terminals connected to the base station; and
a control unit configured to notify the base station of the weight.

The weight calculation unit calculates the weight by repeating processing for updating the weight so that an error between expected wireless communication quality obtained when the weight is given to each of the terminals and required wireless communication quality of each of the terminals is small.

### Advantageous Effects of Invention

According to the disclosed technology, there is provided a technology for appropriately performing scheduling in a wireless system in which a plurality of base stations provides services to users.

### BRIEF DESCRIPTION OF DRAWINGS

FIG. 1 is a diagram illustrating an example of a wireless system.

FIG. 2 is a diagram illustrating a system configuration according to an embodiment of the present invention.

FIG. 3 is a diagram illustrating a configuration of a scheduling control apparatus.

FIG. 4 is a flowchart illustrating an operation of the scheduling control apparatus.

FIG. 5 is a diagram illustrating an operation of the scheduling control apparatus.

FIG. 6 is a diagram illustrating a hardware configuration of a device.

### DESCRIPTION OF EMBODIMENTS

Embodiments of the present invention (present embodiment) will be described below with reference to the drawings. Embodiments to be described below is merely exemplary and embodiments to which the present invention is applied are not limited to the following embodiments.

### Overview of Embodiment

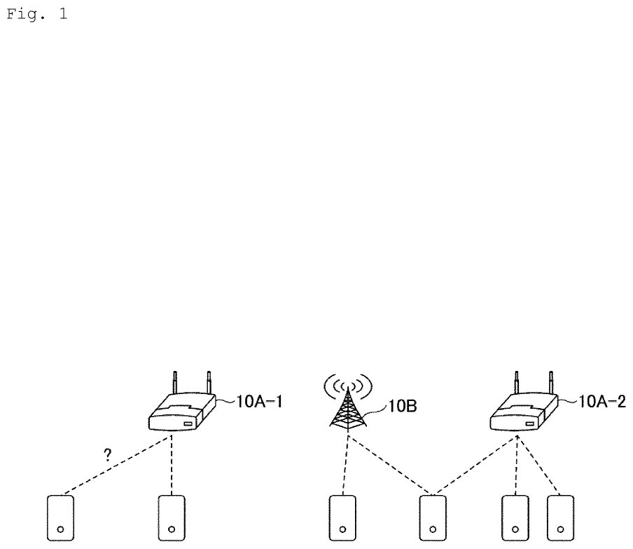

FIG. 1 illustrates a configuration example of a wireless system (also referred to as a wireless communication system) assumed in the present embodiment. However, FIG. 1 illustrates a situation (a situation of the related art) in which a scheduling control apparatus 100 to be described below using the technology of the present invention is not used.

As illustrated in FIG. 1, the wireless system includes, for example, base stations 10A-1, 10A-2, and 10B. Terminals are connected to each base station, as illustrated. A wireless scheme of the base station 10A is different from that of the base station 10B.

As one example, the base station 10A is a wireless LAN base station (access point), and the base station 10B is a base station of a cellular network such as 5G. The terminal can be connected to both the base station 10A and the base station 10B.

In the wireless system illustrated in FIG. 1, connection destination base stations and the connection schemes may be different between the terminals. Scheduling is individually performed in each base station. Therefore, in the technology of the related art, scheduling through which wireless communication quality (for example, throughput) required by each terminal can be provided cannot be appropriately performed.

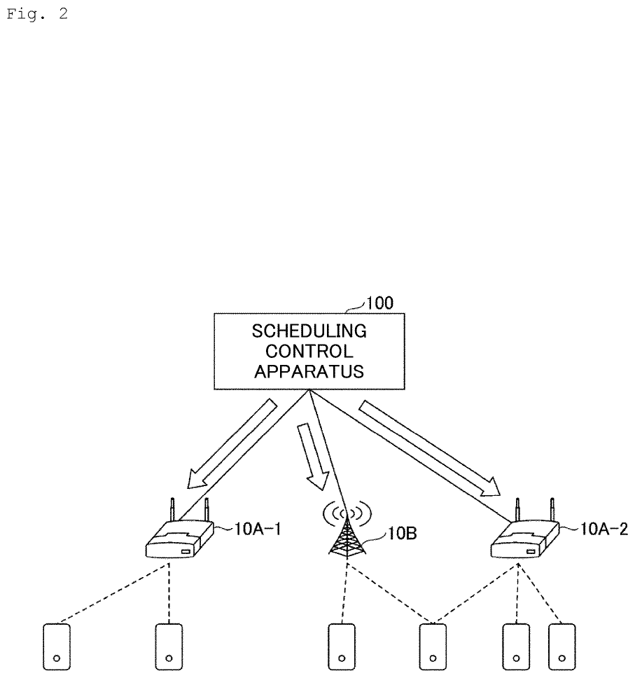

FIG. 2 illustrates a configuration example of a wireless system according to the present embodiment to solve the above-described problem. As illustrated in FIG. 2, the wireless system includes, for example, the base stations 10A-1, 10A-2, and 10B. Terminals are connected to each base station, as illustrated. Further, the scheduling control apparatus 100 connected to each base station via a network is provided. Although the plurality of base stations 10A and 10B having different wireless schemes are illustrated in the example of FIG. 2, the technology of the present invention can be applied to a wireless system that includes a plurality of base stations having the same wireless scheme.

The scheduling control apparatus 100 calculates a weight for each terminal so that wireless communication quality required by each terminal accommodated in a wireless system having a plurality of base stations is satisfied, and notifies each base station of the calculated weight. Each base station performs scheduling for each terminal in accordance with the weight calculated by the scheduling control apparatus 100. In the following description, a throughput is used as a specific example of wireless communication quality in the terminal.

A “weight” for a certain terminal is the proportion of a communication amount allocated to the terminal in the total communication amount that can be allocated by a base station (a base station connected to the terminal) per unit time. In other words, the “weight” indicates the allocation ratio of communication amounts between one or a plurality of terminals connected to a base station.

The term “communication amount” may be a transmission rate, a line capacity, a traffic amount, the number of packets, a resource amount, the number of symbols, the number of slots, or another amount. Target communication to which a communication amount is allocated may be uplink communication, downlink communication, or both uplink communication and downlink communication.

When w is a “weight” for a certain terminal in a certain base station and r is a transmission rate for all terminals connected to the base station, an expected throughput s between the terminal and the base station is calculated as s=r×w. When a terminal is connected to a plurality of base stations, an expected throughput s is obtained by adding r×w for each base station.

### (Device Configuration)

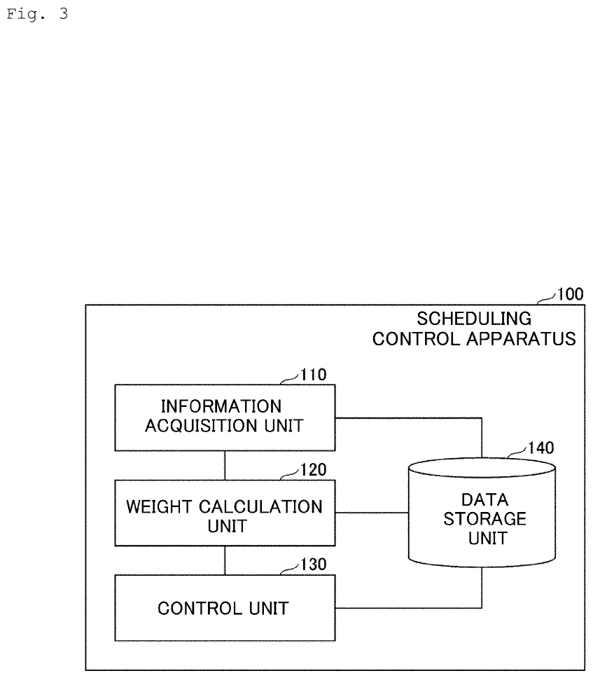

FIG. 3 is a diagram illustrating a configuration of the scheduling control apparatus 100 according to the present embodiment. As illustrated in FIG. 3, the scheduling control apparatus 100 includes an information acquisition unit 110, a weight calculation unit 120, a control unit 130, and a data storage unit 140.

The information acquisition unit 110 acquires information regarding a connection state between a base station and a terminal from, for example, a control device in the wireless system or from each base station. The weight calculation unit 120 calculates a weight. The control unit 130 notifies each base station of information regarding the weight calculated by the weight calculation unit 120.

The data storage unit 140 stores information necessary for the weight calculation unit 120 to calculate a weight. The information necessary to calculating the weight is, for example, a transmission rate of each base station, a required throughput of each terminal, or the like.

### (Operation of Scheduling Control Apparatus 100)

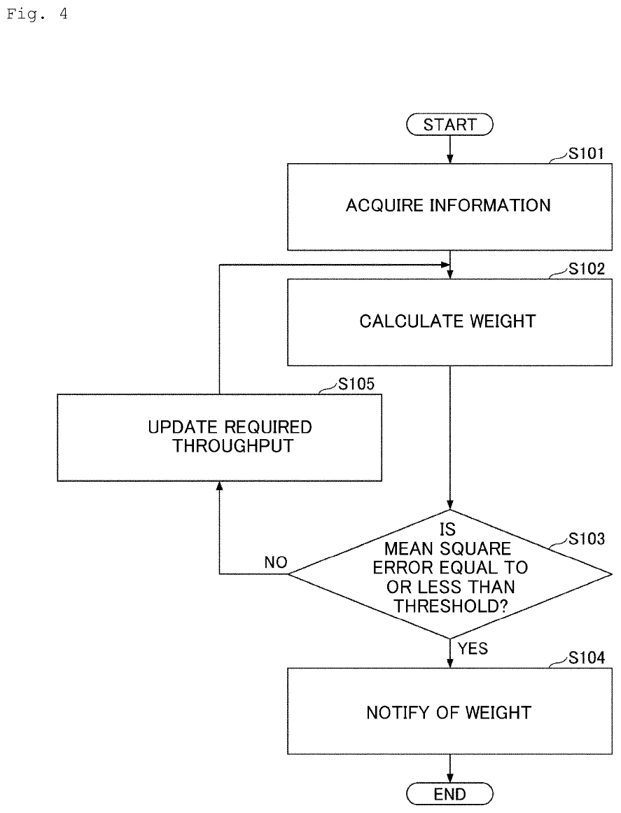

Next, an operation example of the scheduling control apparatus 100 will be described in accordance with a procedure of the flowchart illustrated in FIG. 4.

### <S101: Information Acquisition>

The information acquisition unit 110 acquires information on a base station and a terminal in an area to which the technology according to the present embodiment is applied. For example, the information acquisition unit 110 acquires a connection state between a base station and a terminal (which base station is connected to which terminal) from a control device or the like of the wireless system, and acquires a transmission rate (line capacity) of the base station and the required throughput of the terminal from the data storage unit 140.

### <S102: Weight Calculation Processing>

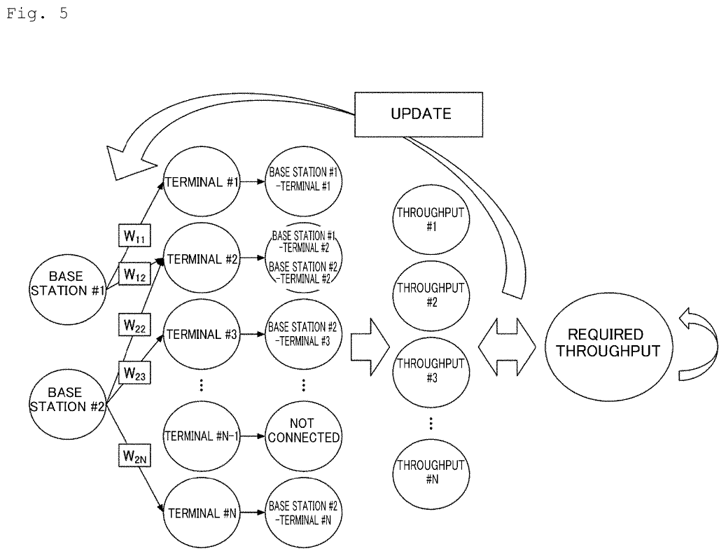

In S102, the weight calculation unit 110 performs weight calculation processing. The weight calculation processing will now be described with reference to a specific example illustrated in FIG. 5.

In the example illustrated in FIG. 5, there are base stations #1 and #2, and terminals #1 to #N as weight calculation targets. FIG. 5 may be regarded as a model of a neural network in which nodes of base stations and nodes of terminals are included and are connected by links having weights. The weights may be parameters of the neural network. The weight calculation unit 110 can construct the model of the neural network based on information acquired by the information acquisition unit 110.

In the example illustrated in FIG. 5, terminals connected to the base station #1 are the terminals #1 and #2, and terminals connected to the base station #2 are the terminals #2, #3, . . . , the terminal #N (the terminal #N−1 is not connected).

Each base station has a transmission rate (line capacity) for terminals (all connectable terminals). Here, a transmission rate of the base station #1 is defined as R1, and a transmission rate of the base station #2 is defined as R2.

When weights illustrated in FIG. 5 are used, an expected throughput TH1 of the terminal #1 (a transmission rate which can be implemented by the terminal) is TH1=w₁₁×R1, and an expected throughput TH2 of the terminal #2 is TH2=w₁₂× R1+w₂₂×R2. The throughputs of the other terminals can be calculated similarly.

Here, a sum of the weights for the same base station is 1. That is, w₁₁+w₁₂=1, and w₂₂+w₂₃+ . . . , w_{2N}=1. It is assumed that an initial value of a weight between a base station and each terminal connected to the base station is given in advance in each base station.

For example, when a required throughput (required throughput) of the terminal #1 is defined as Y1 and Y1 (required throughput)>TH1 (expected throughput) is satisfied, the weight calculation unit 110 updates the weight so that the weight (that is, w₁₁) of the terminal #1 increases. That is, the weight calculation unit 110 updates the weight so that the weight of the terminal of which the expected throughput is less than the required throughput increases.

Here, since a sum of the weights for the same base station is 1, as the weight is updated, the other weights are updated. For example, since w₁₁+w₁₂=1 in the base station #1 to which the terminal #1 is connected, w₁₂ decreases when w₁₁ increases.

By repeating the above-described processing of the weight updating and the expected throughput calculation, the weight is determined so that the expected throughput satisfies the required throughput as much as possible in each terminal.

More specifically, the weight calculation unit 120 can update the weight according to the following update formula.

$$\begin{matrix}g ( W ) = {( y - {w}_{i} \cdot x )}^{2} \\ \partial g ( W ) / \partial {w}_{i} = 2 ( y - {w}_{i} \cdot x ) \\ {w}_{i} = {w}_{i} + ρ ( \partial g ( W / \partial {w}_{i} )\end{matrix}$$

In the above formula, x represents a transmission rate of the base station. wᵢ represents a weight of terminal #i. Each of x and wᵢ is a vector. y is a required throughput of the terminal #i.

wᵢ·x represents an expected throughput of the terminal #i. For example, when the terminal #i is the terminal #2 in the situation of FIG. 5, wᵢ·x=w₁₂×R1+w₂₂×R2 is satisfied.

In g(w) (which is a square value of a difference between the required throughput and the expected throughput), a change amount (∂g(w)/∂wᵢ) (=inclination) for wᵢ is obtained. The inclination is used to update wᵢ by the third formula so that g(w) decreases (=the realization throughput approaches the required throughput). ρ is a predetermined coefficient. This method is a gradient method (which may be referred to as a gradient descent method).

The wᵢ can be calculated for each terminal similarly to the parameter updating (for example, an error back propagation method) of a neural network so that the following mean square error (which may be called “dispersion”) is minimized. In the following formula, E is a sum for the terminals, and N is the number of terminals.

$$( 1 / N ) {{Σ}_{i} ( y - {w}_{i} \cdot x )}^{2}$$

The weight calculation processing (repeated processing of the weight updating and the expected throughput calculation) in S102 is repeated a predetermined prescribed number of times until the mean square error is equal to or less than a predetermined threshold. When the mean square error is not equal to or less than the predetermined threshold as a result of repeating the weight calculation processing the prescribed number of times, the processing of S102 ends.

### <S103, S104, and S105: Weight Output and Throughput Updating>

Next, S103, S104, and S105 in the flow of FIG. 4 will be described.

In S103, the weight calculation unit 110 determines whether the mean square error is equal to or less than the threshold.

When a determination result of S103 is Yes (mean square error≤threshold), in S104, the weight calculation unit 110 transfers the weights of all the terminals to the control unit 130. The control unit 130 notifies each base station of the weight(s). The control unit 130 may notify the base station of only the weight(s) related to the base station. For example, in the example illustrated in FIG. 5, the base station #1 is notified of w₁₁ and w₁₂.

Each base station receiving the weight(s) performs scheduling according to the weight(s). As an example, a communication operation of distributing resources in a time-division manner will be described. For example, in the connection state of FIG. 5, the base station #1 receiving w₁₁ and w₁₂ communicates with the terminal #1 at “w₁₁×unit time” and communicates with the terminal #2 at “w₁₂×unit time”.

When the determination result of S103 is No (mean square error>threshold), the processing proceeds to S105. The weight calculation unit 110 updates the required throughput and performs the weight calculation processing of S102, using the updated required throughput.

Since the required throughput is a throughput required for the terminal, an initially set value of the required throughput may be basically used as long as an initially set value can be used as it is.

However, even if the weight updating processing is repeated, the mean square error is not equal to or less than the threshold in some cases. In these cases, the required throughput is updated, and the weight update processing is performed using the updated required throughput, so that the mean square error becomes equal to or less than the threshold. By using the weight and the required throughput so that the mean square error becomes equal to or less than the threshold, it can be expected that communication in which the radio resources of the wireless system are used most efficiently can be performed.

An initial value of the required throughput is not necessarily set for each terminal. That is, the initial value of the required throughput may be set to a predetermined appropriate value.

Although a method of updating the required throughput is not limited to a specific method, the following updating formula can be used, for example.

$$\begin{matrix}f ( W ) = {( y - {w}_{i} \cdot x )}^{2} \\ \partial f ( W ) / \partial y = 2 ( y - {w}_{i} \cdot x ) \\ y = y + α ( \partial f ( W / \partial y )\end{matrix}$$

As in the foregoing formula, the required throughput y is changed at a rate of change of ∂f(W)/∂y. α is a predetermined coefficient. This method is a gradient method (which may be referred to as a gradient descent method). The larger f(W) (mean square error) is, the larger (an absolute value) of ∂f(W)/∂y is. Therefore, y can be changed greatly.

### (Example of Hardware Configuration)

The scheduling control apparatus 100, the base station, and the terminal can all be implemented, for example, by causing a computer to execute a program. The computer may be a physical computer or a virtual machine on a cloud. The scheduling control apparatus 100, the base station and the terminal are collectively called devices.

That is, the device can be implemented by executing a program corresponding to the processing performed by the device using hardware resources such as a CPU and a memory contained in a computer. The foregoing program can be recorded on a computer-readable recording medium (a portable memory or the like) to be stored or distributed. The foregoing program can also be provided through a network such as the Internet or an e-mail.

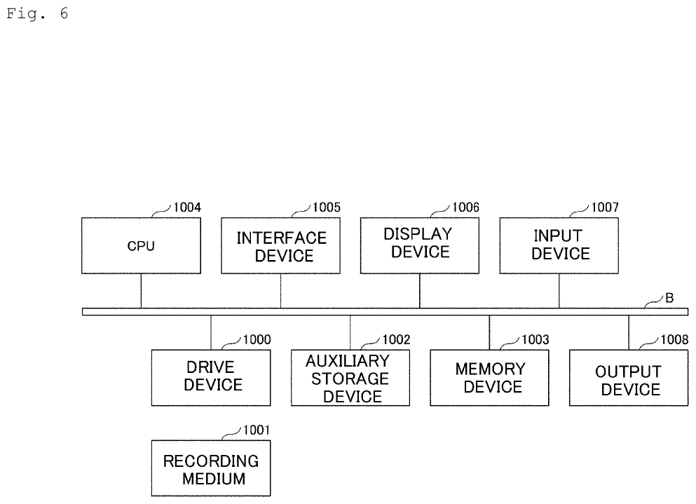

FIG. 6 is a diagram illustrating a hardware configuration example of the computer. The computer illustrated in FIG. 6 includes a drive device 1000, an auxiliary storage device 1002, a memory device 1003, a CPU 1004, an interface device 1005, a display device 1006, an input device 1007, and an output device 1008 connected to each other via a bus BS.

A program implementing processing in the computer is provided by, for example, a recording medium 1001 such as a CD-ROM or a memory card. When the recording medium 1001 that stores a program is set in the drive device 1000, the program is installed from the recording medium 1001 to the auxiliary storage device 1002 via the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 implements functions related to the device in accordance with the program stored in the memory device 1003. The interface device 1005 is used as an interface for connection to a network or the like. The display device 1006 displays a graphical user interface (GUI) or the like by the program. The input device 1007 is configured with a keyboard, a mouse, a button, a touch panel, or the like, and is used to input various operation instructions. The output device 1008 outputs a calculation result.

### Advantageous Effects of Embodiment

According to the technology according to the above-described present embodiment, scheduling for providing wireless communication quality (a throughput or the like) required by the terminal can be performed in a situation where the connection destination base station of each terminal and wireless communication quality are different.

### (Supplements)

The following supplements will be disclosed according to the above-described embodiments.

### (Supplement 1)

A scheduling control apparatus that calculates a weight for scheduling a terminal in a wireless system including a plurality of base stations, the scheduling control apparatus comprising:
a memory; and
at least one processor connected to the memory, wherein
the processor executes:
acquiring information regarding a connection state between each of the plurality of base stations and the terminal; calculating, for each base station of the plurality of base stations, a weight indicating an allocation ratio of communication amounts between one or a plurality of terminals connected to the base station; and
notifying the base station of the weight,
wherein the processor calculates the weight by repeating processing for updating the weight so that an error between expected wireless communication quality obtained when the weight is given to each of the terminals and required wireless communication quality of each of the terminals is small.

### (Supplement 2)

The scheduling control apparatus according to Supplement 1, wherein the processor calculates the weight so that a mean square error between the required wireless communication quality and the expected wireless communication quality is equal to or less than a threshold.

### (Supplement 3)

The scheduling control apparatus according to Supplement 2, wherein the processor updates the required wireless communication quality when the mean square error is not equal to or less than the threshold after the processing is repeated a prescribed number of times, and calculates the weight using the updated required wireless communication quality.

### (Supplement 4)

A scheduling control system comprising:
the scheduling control apparatus according to any one of Supplements 1 to 3 and the plurality of base stations, wherein each of the plurality of base stations executes scheduling for each of the terminals to be connected by using the weight received from the scheduling control apparatus.

### (Supplement 5)

A scheduling control method executed by a computer that calculates a weight for scheduling a terminal in a wireless system including a plurality of base stations, the method comprising:
an information acquisition step of acquiring information regarding a connection state between each of the plurality of base stations and the terminal;
a weight calculation step of calculating, for each base station of the plurality of base stations, a weight indicating an allocation ratio of communication amounts between one or a plurality of terminals connected to the base station; and a control step of notifying the base station of the weight, wherein, in the weight calculation step, the weight is calculated by repeating processing for updating the weight so that an error between expected wireless communication quality obtained when the weight is given to each of the terminals and required wireless communication quality of each of the terminals is small.

### (Supplement 6)

A non-transitory storage medium storing a program that can be executed by a computer to perform weight calculation processing for calculating a weight for scheduling a terminal in a wireless system including a plurality of base stations, the weight calculation processing comprising:
acquiring information regarding a connection state between each of the plurality of base stations and the terminal;
calculating, for each base station of the plurality of base stations, a weight indicating an allocation ratio of communication amounts between one or a plurality of terminals connected to the base station; and
notifying the base station of the weight,
wherein, the weight is calculated by repeating processing for updating the weight so that an error between expected wireless communication quality obtained when the weight is given to each of the terminals and required wireless communication quality of each of the terminals is small.

Although the embodiment has been described above, the present invention is not limited to the specific embodiment, and various modifications and changes can be made within the scope of the gist of the present invention described in the claims.

### REFERENCE SIGNS LIST

10A, 10B Base station
100 Scheduling control apparatus
110 Information acquisition unit
120 Weight calculation unit
130 Control unit
140 Data storage unit
1000 Drive device
1001 Recording medium
1002 Auxiliary storage device
1003 Memory device
1004 CPU
1005 Interface device
1006 Display device
1007 Input device
1008 Output device

1. A scheduling control apparatus that calculates a weight for scheduling a terminal in a wireless system including a plurality of base stations, the scheduling control apparatus comprising:
a processor; and
a memory storing program instructions that cause the processor to:
acquire information regarding a connection state between each of the plurality of base stations and the terminal;
calculate, for each base station of the plurality of base stations, a weight indicating an allocation ratio of communication amounts between one or a plurality of terminals connected to the base station; and
notify the base station of the weight,
wherein the program instructions cause the processor to calculate the weight by repeating processing for updating the weight so that an error between expected wireless communication quality obtained when the weight is given to each of the terminals and required wireless communication quality of each of the terminals is small.

2. The scheduling control apparatus according to claim 1, wherein the program instructions cause the processor to calculate the weight so that a mean square error between the required wireless communication quality and the expected wireless communication quality is equal to or less than a threshold.

3. The scheduling control apparatus according to claim 2, wherein the program instructions cause the processor to update the required wireless communication quality when the mean square error is not equal to or less than the threshold after the processing is repeated a prescribed number of times, and calculate the weight by using the updated required wireless communication quality.

4. A scheduling control system comprising:
the scheduling control apparatus of claim 1; and
the plurality of base stations,
wherein each of the plurality of base stations executes scheduling for each of the terminals to be connected by using the weight received from the scheduling control apparatus.

5. A scheduling control method executed by a computer that calculates a weight for scheduling a terminal in a wireless system including a plurality of base stations, the method comprising:
acquiring information regarding a connection state between each of the plurality of base stations and the terminal;
calculating, for each base station of the plurality of base stations, a weight indicating an allocation ratio of communication amounts between one or a plurality of terminals connected to the base station; and
notifying the base station of the weight,
wherein, in the calculating of the weight, the weight is calculated by repeating processing for updating the weight so that an error between expected wireless communication quality obtained when the weight is given to each of the terminals and required wireless communication quality of each of the terminals is small.

6. A non-transitory computer-readable recording medium storing a program configured for causing a computer to execute the scheduling control method of claim 5.
